(19) United States
(12) Patent Application Publication
(10) Pub. No.: US 2018/0001182 A1
(43) Pub. Date: Jan. 4, 2018

(54) Patent Application for Athletic Training Device

(71) Applicants: Victor Szanto, Glenbrook, NV (US); Evye Szanto, Glenbrook, NV (US)

(72) Inventors: Victor Szanto, Glenbrook, NV (US); Evye Szanto, Glenbrook, NV (US)

(21) Appl. No.: 15/199,146

(22) Filed: Jun. 30, 2016

(51) Int. Cl. A63B 71/06; A63B 33/00; G02C 11/00

(52) U.S. Cl. CPC A63B 71/0686; A63B 71/0622; G02C 11/10; A63B 33/002; A63B 2071/0666; A63B 2220/62; A63B 2244/20; A63B 2208/03

(57) ABSTRACT

An electronic athletic pacing device that couples to eye-wear, including swim goggles and sun glasses. The device includes LEDs that provide indications of the end of time intervals. Buttons and a display are used to configure the timer periods, modes, starting, stopping. The electronic module provides the timing, and controls the LEDs and provides and interval training mode that restarts a first timer at the end of the second timer interval time. The LEDs are positioned so that they are visible to an athlete wearing the eye-wear and configured to couple to the eye-wear nose piece.

### FIELD OF THE INVENTION

The various embodiments of the invention relates to electronic timing devices that help with athletic training by providing pacing information and controlled time intervals during swimming, running, biking, and other athletic activities where knowing a time period an interval time, or average speed is useful for training or performance.

### BACKGROUND OF THE INVENTION

The inventors are long time exercise enthusiast engaging in activities that includes running, swimming, and biking. A long standing issue for them and other athletes has been methods to measure and pace their athletic performance. While it is easy to determine the beginning and ending workout time to determine an average pace, it is not easy to determine a pace during training. Further, with interval training, where the interval time is not a whole minute, it is difficult to follow and remember clock times. Thus it is difficult to fine tune a person's training.

This pacing problem is especially difficult for swimming. A swimmer's senses are diminished in the water. Hearing is impaired by the water and potentially by a swim cap. Thus, sound based methods of providing a pacing feedback are problematic. Looking up at a clock each lap can break the swimmer's rhythm. Often a flip turn is performed each pool length and looking at a clock and performing a flip turn are incongruent activities. Further, mentally calculating a time distracts a swimmer's mental concentration by requiring that the swimmer to remember the old time, current time, and perform a mental calculation of their current pace. Looking a one's wrist would break the pace and rhythm of swimming laps and thereby slows the swimmer down.

For running, having to look at one's wrist can break a runner's pace and concentration. During biking, looking down at a device takes a rider's focus off the road or track which can be dangerous, and looking at a wrist device requires the release of a bike's handle bar which again is dangerous.

Additionally, during interval training (described below), an athlete will rest for a time period after an exercise period. If the athlete wants to repetitively exercise for fifty three seconds and rest for forty six seconds, it is difficult to look at a clock and precompute the new next time to start.

What is needed is a method and device that provides an indication of one or more time periods and provides an interval time mode where an exercise time is restarted at the end of a an interval time period, or provides a pace indication that is easily detectable by a wearer of eye-wear without moving the users arm or head while swimming, running, biking, or performing other athletic activities. This need has led to the invention in its various embodiments shown and described below.

### BRIEF DESCRIPTION OF THE DRAWINGS

FIG. 1 is a view of the pacing device coupled to swim goggles.

FIG. 2 is a view of the pacing device integrated into swim goggles.

FIG. 3 is a view of the pacing device coupled to sun glasses.

FIG. 4 is alternative embodiment of the pacing device couple to sport glasses.

FIG. 5 shows a block diagram of the logic components for controlling the pacing device.

FIG. 6A is an illustration showing the relationship between LED indications, an exercise timer, and an interval timer in an interval training mode.

FIG. 6B is an illustration showing the relationship between LED indications, an lap timer, and an interval timer in an interval training mode.

FIG. 7 is a block diagram of a method of an athlete using a pacing device for interval training.

### SUMMARY OF THE INVENTION

An athletic pacing device, coupled or integrated into eye-wear that provide a visible indication from one or more LEDs (light emitting devices) at the end of one or more repetitive time periods. The eye-wear can include swim goggles or glasses.

The LEDs can be blinked one or more times and are preferably positioned to be in the peripheral vision of the athlete wearing the eye-wear. The pacing device can be positioned on the side of the eye-wear but preferably is coupled centered over the nose bridge.

Programming of the device can be implemented using buttons and a display. An electronic module controls the timers, display, LEDs, and inputs from the buttons.

Further, the device can include a second LED and second timer that outputs a visual indication when the second timer counts down. In one configuration, the pacing device includes an interval training mode. In this mode, the first timer is restarted at the end of the second timer interval.

### DETAILED DESCRIPTION OF THE INVENTION

The following description is provided as an enabling teaching of several embodiments of the invention disclosed. Those skilled in the relevant art will recognize that many changes can be made to the embodiments described, while still attaining the beneficial results of the present inventions. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

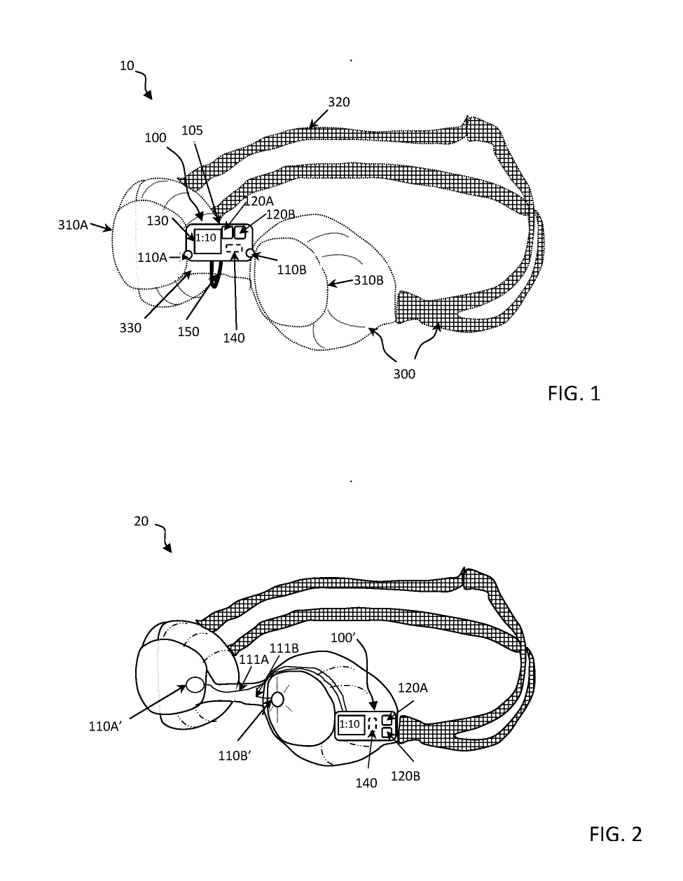

FIG. 1 shows one embodiment of the invention but is not intended to limit the invention scope. While the specific examples are for swim goggles and sun glasses, this inventive concept is applicable to other eye-wear including but not limited to eye glasses, protective goggles, and ski goggles. Accordingly, the use of “eye-wear” includes swim goggles, sun glasses, ski goggles, glasses, and protective goggle. While the use of the invention refers to an athlete, the pacing device can be use by a person of any athletic ability or capability.

The swim goggle pacing system 10 is comprised of swim goggles 300 and a pacing device 100 coupled to the swim goggles 300. As shown, the swim goggles 300 include a first eye cup 310A, a second eye cup 310B, a head strap 320, and a nose piece 330.

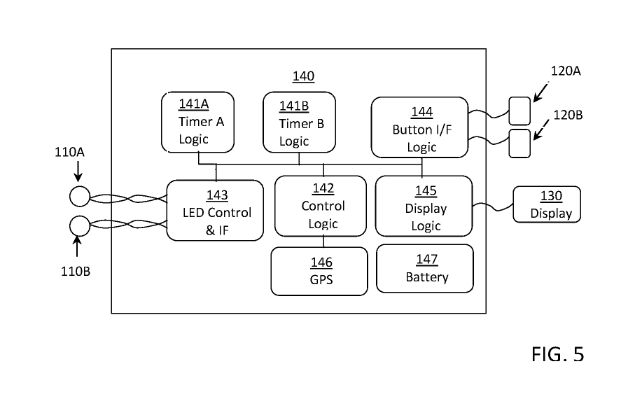

Coupled to the goggles 300 is the pacing device 100. The pacing device 100 includes an electronics module 140-FIG. 5 that includes one or more timers that count down one or more repetitive periods and generates an associated visual indication at the end of an associated time period.

Preferably, the associated visual indication is generated at the end of an associated time period is visible light. The visual indication needs to be visible to an athlete (not shown) wearing the goggles 300. Further, the electronic module 140 can be configured to couple two timers in a manner that provides an Interval Training mode. This mode is discussed in further detail below.

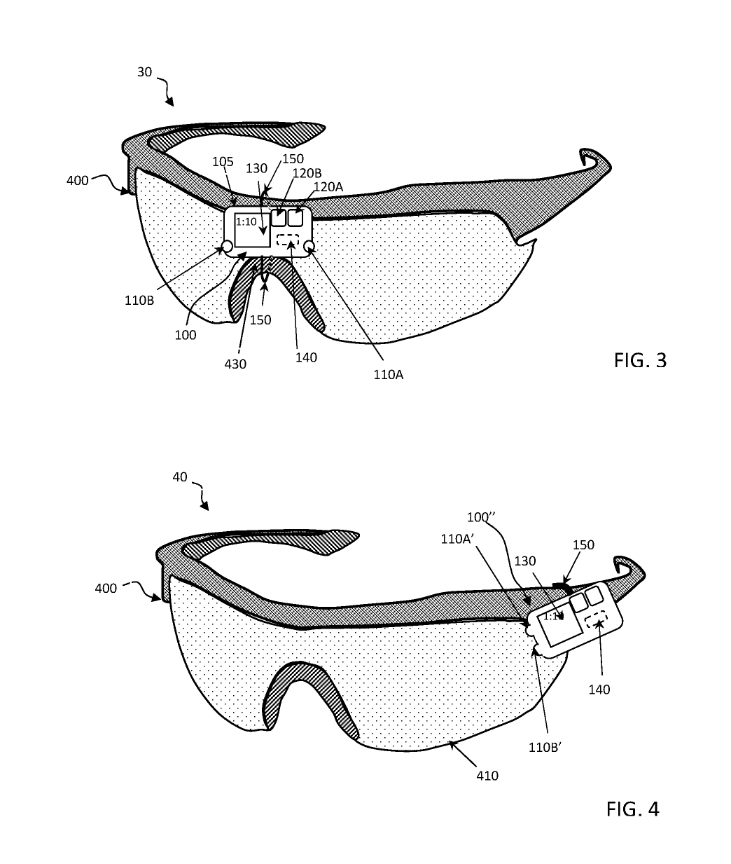

The coupling of the pacing device 100 to swim the goggles 300 can be provided by any known means for coupling a device weighing less than three ounces to the googles 300 or other eye-wear. As shown in FIG. 1 and FIG. 3, a strap 150 is shown coupling the device 100 to the swim goggle's nose piece 330 and the sunglasses nose bridge 430. The strap 150 can be made of an elastic or inelastic material. Hooks or a buckle (not shown) can engage holes (not shown) in the strap 150 to fasten the device 100 to the goggles bridge 330. However, the coupling means can include, but is not limited to a clip, a Velcro strap, a snap, a mounting plate, an adhesive, a suction device, or a combination thereof. Further, the coupling can be by the means of integrally forming the device 100 into the eye-wear.

The pacing device 100 can include a waterproof or water resistant case 105 that protects the internal electronics and other components that could be impaired or damaged by contact with water, salt water, or an athlete's sweat. Further, the case 105 should be configured so that when the device 100 is coupled to the swim goggles nose bridge 330-FIG. 1, the running/biking sunglass nose bridge 430-FIG. 3, or other eye-wear nose bridge that the LEDs (light emitting devices) 110A, 110B are in front of the plane of a athlete's eyes and visible by the athlete wearing the goggles 300 or sunglasses 400. This can require that the LEDs 11A, 11B are in or in front of the plane of the goggle lenses 310A, 310B and preferably in the peripheral vision of the athlete. However, other LEDs 110A, 110B positions behind the plane of the eye are contemplated. In these positions, reflections and transmission of LEDs 110A, 110B light through the goggle lenses or cups reach the athlete's eye. For example, the LED's 110A, 110B light can be directed into a translucent eye cup which is visible to the athlete wearing the goggles.

Preferably, the brightness of the LEDs 110A, 110B are sufficiently bright to be seen by an athlete when used outdoors in direct sunlight. For the purposes of this application, the term LED is broader than the commonly used meaning—light emitting diodes—LED includes all types of light emitting devices currently know or unknown. One skilled in the art of electronics and developing electronic devices used outdoors would be able to develop a design using an LED providing the needed brightness without undue experimentation.

The pacing device 100 includes an electronics module 140, one or more LEDs 110A, 110B, one or more buttons 120A, 120B, and a display 130. The electronics module 140 processes inputs from the buttons 120A, 120B to set device 100 operating modes, start timers, set device 100 configurations, and enable and disable the one or more LEDs 110A, 1106. While two buttons 120A, 120B are shown, one or more buttons are contemplated. Further, other means of user input are contemplated including slide switches, and inputs by remote wireless means.

The buttons 120A, 120B provide control and configuration of the pacing device 100. The buttons 120A, 120B can be used to set of one or more repeating time period, setting paces for running or biking, setting modes (swim/bike/run) including an interval training mode (see description below), starting and stopping the one or more timers, and setting configurable parameters such as parameters for the LEDs 110A, 110B including but not limited to the number of blinks for an indication, blink rates, and blink colors, and blink brightness.

The display 130 provides user feedback for the device 100 configuration, including but not limited to which mode is set (timer, interval training, or clock), setting a time period for the one or more timers and setting a pace time. Alternative device modes can include but not limited to a stop watch function, and timer status. The display 130 is not intended for user viewing while swimming, running, or biking. The display is preferably a low-power LCD (Liquid Crystal Display) but other display types are contemplated. The display needs to be light because it will be mounted on the goggles or other eye-wear.

The electronics module 140 includes one or more timer circuits and in an alternative embodiment, includes or exclusively has GPS (Global Positioning Service) electronics 146-FIG. 5 for determining an instantaneous or average pace in contrast to a time period.

In a first embodiment, the electronics module 140 includes a first timer circuit 141A-FIG. 5. When enabled, the electronics module 140 is configured to blink the first LED 110A one or more times at the end of the user configured first time period. The end of the first interval occurs when the first interval timing circuit 141 counts down the user configured time period. When the pace device 100 is started, the first timer 141 repeatedly counts down a user configured time period with the first timer 141 being reloaded with the user configured time period at the end of the time period.

Preferably, the electronics module 140 blinks the LED 110A between one to five times at the end of each time period. Having multiple blinks assures that the athlete wearing the goggles sees the visual indication. The duration of the blink is preferably between 0.20 and 0.5 second. The time between blinks is preferably between 0.20 and 1.00 seconds. These associated blink times can be fixed or user configurable.

The time resolution of the first timer 141 should be at least one half of a second. An athlete can set the first timer for a target time to complete a lap or other known distance. The athlete may want to slightly decrease the time to push their performance. Thus, the resolution of the time interval should be sufficiently small for an athlete to fine tune his lap time.

The time, the brightness, and number of blinks of the LEDs 110A, can be fixed or configurable by the athlete using the one or more buttons 120A, 120B and the display 130.

In another embodiment, the electronics module 140 includes a second interval timing circuit 141B. When enabled, the electronics module 140 is configured to blink the LED 110B at the end of each user selected second time period. Preferably, the electronics module 140 blinks the second LED 110B one to five times. The second LED 110B should be distinguishable from the first LEDs 110A either by color, brightness, position, or the length of the blink.

In one application, the second LED 110B is used to set the length of the entire workout. In another application, a runner or biker might use the second timer as a reminder to consume nutrition, to hydrate, or other significant event.

One skilled in the art of designing low powered digital electronics would know how to design and build the electronics module 140 to perform the functions and control specified above.

The LEDs 110A, 110B are preferably a low power component that is positioned to be viewable by an athlete with the pacing device 100 coupled to the goggles' bridge 330 or sunglasses' bridge 430. Preferably, the LED 110A, 110B is in the peripheral vision of an athlete and is configured to clip or strap to the goggles nose piece 330 or sunglasses nose piece 430-FIG. 3 or other eye-wear. However, other embodiments are contemplated. For example, the interval timing device can be coupled to the side of the goggles with the LED on a configurable extension (not shown).

The brightness of the LEDs 110A, 110B needs to be sufficient to be visible to an athlete swimming in a pool or while running or riding in full sunlight but not so bright to affect their vision. This is important because it would be dangerous to temporally impair the vision of a biker or runner.

Another important aspect of the invention is the color of the LEDs 110A, 110B. Preferably they are different colors to help in distinguishing the different timing intervals. The LED should not emit blue light because swimming pools are often tinted blue and a blue light washes out making it more likely that an athlete would miss the LEDs blinks or flashes. Preferably, the LED's 110A, 110B emit different colors to help distinguish the different timing intervals. In one embodiment, the LEDs 110A can be red and the second LED 110B can be yellow. In another embodiment, the color of the LEDs 110A, 110B are configurable to two or more colors selected from red, yellow, white, and green.

Preferably the first LED 110A and the second LED 110B are positioned on opposing sides of the pacing device 100 and adjacent to the goggle lenses 310A, 310B as shown in FIG. 1 and FIG. 3. However, other positions and LED orientations are contemplated (see FIGS. 2 and 4).

Referring to FIG. 2, swim goggles 20 with the pacing device 100′ integrally formed into the goggles 20 are show and described. The LEDs 110A′, 110B′ do not have to be adjacent to the pacing 100′ and its associated electronics. The LEDs 110A′, 110B′ can be coupled with the pacing device 100′ by wires 111A, 111B integrally formed into the goggle body 20.

Referring to FIG. 3, a pair of biking or sun glasses 30 is shown with the pacing device 100 is attached to the nose bridge 430 of the glasses 400. The form and function of the pacing device 100 can be the same as for the swim goggles or can be an alternative embodiment of the pacing device 100 with the GPS functionality for rate tracking.

In the GPS embodiment, the athlete inputs a target pace. For biking it can be a target miles per hour. For running, the target pace can be minutes per mile. At a periodic interval (either fixed or configurable), fifteen seconds for example, a LED blinks indicating whether you are on the target pace, below the target pace, or above the target pace.

For example, a runner might set the target pace to be eight minutes per mile. While running, an LED will blink green every fifteen seconds to indicate that the runner is on pace. If the pace drops a set or configurable amount below the target pace, say eight and a half minutes per mile, then an LED will blink yellow. If the runner's pace goes above the target pace by a set or configurable amount, say six and one half minutes per mile, then an LED will blink red. Other colors of LED are contemplated. The pace can be determined over a short interval, fifteen second for example, or over a longer set or configurable time.

Referring to FIG. 4, a different configuration of the LEDs 110A′ and 110B′ is shown. In this device embodiment 100″ both the first and second LED 110A′, 110B′ can be positioned on the same side of the pacing device 100″, coupled to the biking glasses 400 or swim goggles 300 on the side and adjacent to only one eye. The pacing device 100″ and LEDs 110A′ and 110B′ needs to be configured so that the LEDs 110A′, 110B′ are visible in the peripheral vision of the athlete.

Referring to FIG. 5, the electronics module 140 for an embodiment of the pacing device 100 is shown. The electronics module 140 includes device control logic 142, button interface logic 144 configured to interface with the one or more buttons 120A, 120B, display interface logic 145 coupled to the display 130, LED electronics 143 for interfacing with the one or more LEDs 110A, 1106, and electronics and logic for determining a pace, an interval or a combination thereof. The pacing timer electronics 141A, 141B provides timing for one or more timer periods and interval times. Alternatively, or in addition to the timers 141A, 141B, one embodiment of the pacing device 100, 100′can include GPS (Global Positioning System) electronics 146 to determine an athletes' pace. Functionally, the control logic 142 and button logic 144 receives indications from the buttons 120A, 120B, controls what appears on the display 130, and controls the LEDs 110A, 1106, and can initialize, control and receive data from the GPS 146. The controller electronics 140 includes a power source 147 which is preferably a small light weight long lasting battery. For the pacing device 100 including the GPS electronics 146, the unit preferably includes a rechargeable battery.

### Interval Training Mode and Method

### Interval Training Mode

In one pacing device configuration, the electronic module 140 control logic 142 is configured to an “Interval Training” mode. The Interval Training mode is a configuration of two coupled timers used when an athlete swims, bikes, runs intervals, or performs or completes an interval based training activity. An interval sequence or interval training consists of an exercise period of running, swimming, biking, or other interval activity for a predetermined exercise time, a rest time, and then repeating the interval training sequence. For ideal athletic training, the exercise time is longer than the rest time.

As a non-limiting example for interval swim training, an athlete might want to sprint swim one hundred meters in one hundred seconds, rest for thirty seconds, and then repeat the interval training sequence. While the device is configured in the Interval Training mode, a second timer is configured for an interval training time (one hundred thirty seconds). The first timer is configured for an exercise time period (one hundred seconds). In the Interval Training mode, the first timer is restarted when the second timer starts a new interval training sequence.

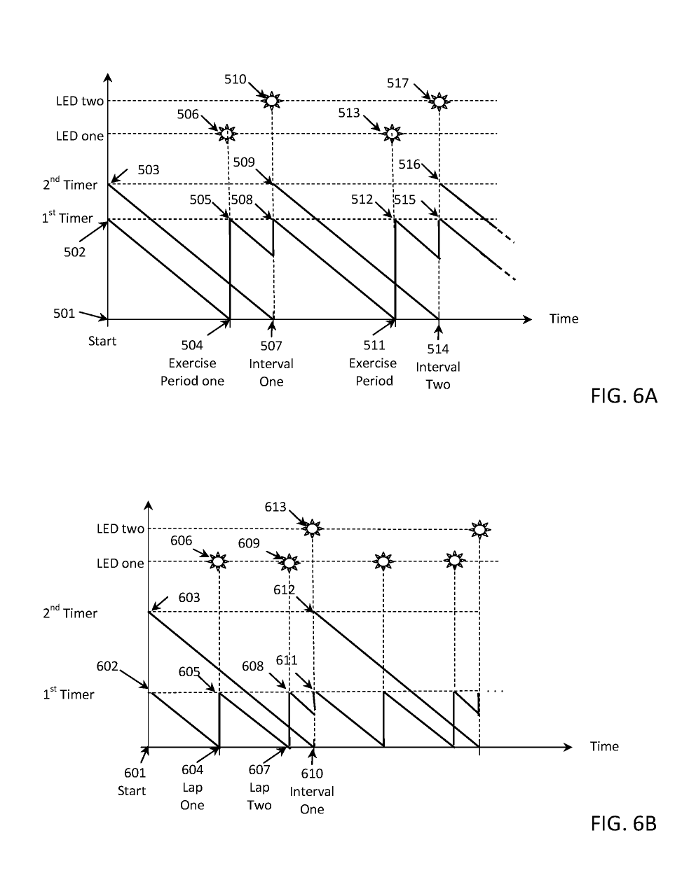

Referring to FIG. 6A, the Interval Training mode sequence with respect to the first timer 141A, second timer 141B, and the first and second LED indications are shown. To start the interval training, the athlete presses a button 120A-FIG. 1 on the device 100 to start the interval training. The timing of this event is shown at 501. The first timer is set at the exercise time 502 and the second timer is set at the interval training time 503. Both the first and second timer count down from each respectively configured times.

When the first timer counts down to zero 504, the first LED provides an indication 506 (one or more blinks) of the end of the exercise time period. The first timer is reset to start counting down 505 for another exercise time period. Note, in other embodiments, the first timer could be disabled until the second timer counts down to zero before restarting the first timer. Further, while in this example the timers are shown counting down, other means of timing are contemplated including but not limited to up counting timers, using a micro-controller to implement the timers, or a combination thereof. One skilled in the art of digital electronics design would be able to design a low power and cost effective electronic module design that provides the above timing function.

If the athlete completes the swim distance before the first LED indication 506, then the athlete knows that his pace is faster than his target pace. If the LED indication 506 occurs during the exercise time, then the athlete knows that his pace is slower than his target pace. Upon swimming his target distance (one hundred meters), the athlete rests for the remainder of the interval training time (approximately thirty seconds). At the end of this time 507, the second LED generates a visual indication 510 and the second timer is reset 509 and begins to time the next training interval. The first timer, timing an exercise time period, is also restarted 508 to time the exercise time period for the second interval.

This pattern repeats for each interval training sequence. The first timer times the exercise time period 511. An indication 513 is generated at the end of the exercise time period. The second timer continues to time the second training interval. At the end of the second training interval 514, the first timer is restarted 515 to time another exercise training interval, the second timer is reset 516 to time another training interval and the second LED generates and indication 517 to begin another training interval.

Referring to FIG. 6B, shows another method of use of the Interval Training mode. In this mode, the athlete may want to track their pace at a finer resolution. An athlete may want to know if they are on pace each lap they run or swim. The pacing device 100 is configured to the Interval Training mode. A first timer is set to a target lap or pool length time 602. The second timer is again set to the interval training time 603 which includes a rest time. A start button on the device 100 is pressed and the first and second timer starts counting down.

When the first timer reaches the configured lap time 604, the first timer is reset and restarted 605 and the first LED generates a visual indication 606. Based on whether the indication 606 is before or after completing the lap, the athlete knows whether they are ahead or behind their target lap pace.

As the athlete swims the next lap, the first timer counts down the lap time, at the lap two target time 607 the first LED generates a visual indication 609 perceivable by the athlete. Again, based on the timing of the indication 609, the athlete knows whether they are ahead or behind their target pace. The first timer again resets 611 and starts timing a third lap which the athlete might not be swimming as a result of the rest period. At the end of the interval training time 610, the second LED generates a visual indication 613 to start the next training interval. This continues for as long as the athlete wants to do intervals.

### Interval Training Method

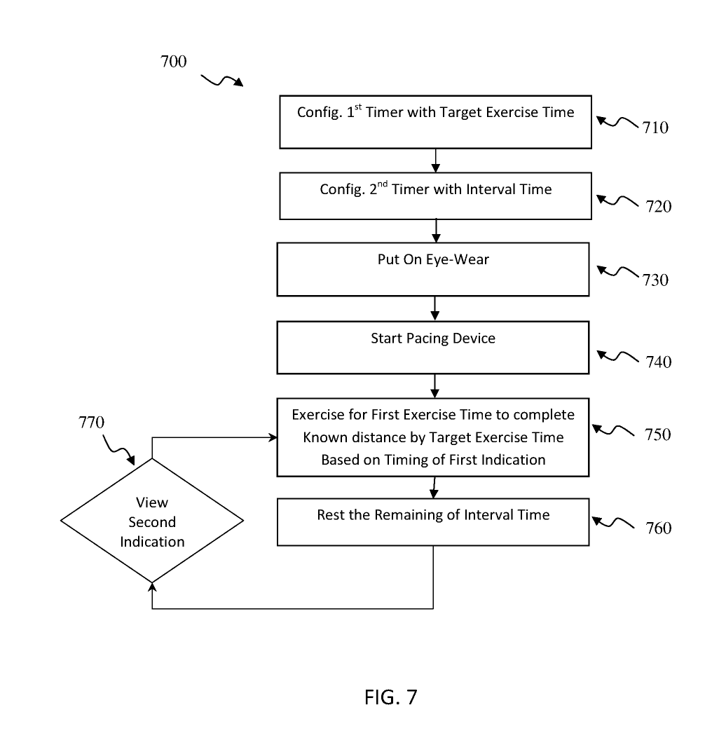

Referring to FIG. 7, a method 700 of interval training using a pacing device is shown and described.

In a step 710, a first timer of a pacing device is configured to a target exercise time. This time is preferably less than the interval time and is chosen to correspond to the time that an athlete wants to complete the exercise for an interval training sequence. For example, the first timer can be set for the target time to swim four laps, or sprint around a track, or bike around a course, or complete a weight lifting sequence.

In a step 720, the pacing device's second timer is configured to an interval time. The interval time is the target exercise time plus a rest time. For example, in an athlete target was to swim a target distance in one hundred second and rest for thirty seconds. The second timer is configured to one hundred and thirty seconds.

In a step 730, the athlete puts on the eye-wear. The eye-wear can be but is not limited swim goggles or sunglasses.

In a step 740, the pacing device is started. The starting of timers in the interval mode can be performed by means including but not limited to pressing a button, flipping a switch, or a timed delay.

In a step 750, the athlete exercises until completing the interval exercise. This can include swimming, running or biking a predetermined distance. The pace of the swimming, running, biking, or other exercise is modified by the athlete as the indications from the first LED is received. If the athlete sees the first LED indication before completing the target exercise, then the athlete will push harder to increase his pace for the next training interval or the rest of the training interval.

In a step 760, the athlete rests to the end of the interval training time. Preferable this time period is less than the target exercise time. At the interval training time, the first timer is restarted for the new interval sequence.

In a step 770, the athlete sees the second visual indication. The second indication indicates to the athlete to start a new exercise time. The method continues at the step of 750 where the athlete adjusts their pace depending on whether they were ahead or behind the target pace.

What is claimed:

1. A electronic athletic pacing device comprising:
a first LED;
a means for generating user inputs;
a display;
an electronics module comprising a first timer, a means for controlling the first LED, a means to control the display, and a means to receive the user inputs; and
an enclosure encapsulating the electronics module and the display, wherein the electronics module is coupled to the first LED, the means for generating user inputs, and the display, wherein the electronics module is configured to control the first timer to repetitively time a first time period, wherein the first LED is configure to be visible by an athlete wearing the pacing device when the pacing device is coupled to eye-wear, and wherein the electronics module is configured to generated a first indication with the first LED during each first time period.
an enclosure encapsulating the electronics module and the display.

2. The electronic pacing device of claim 1, wherein the first indication is one or more blinks of the first LED at the end of the first time period.

3. The electronic pacing device of claim 2, wherein the first LED is configured to be in the peripheral vision of an athlete when wearing the eye-wear.

4. The electronic athletic pacing device of claim 3 further comprising;
eye-wear, wherein the enclosure is integrally formed into the eye-wear.

5. The electronic athletic pacing device of claim 4, wherein the eye-wear is swim goggles having a first and second eye cup, wherein the pacing device is coupled between the first and second eye cup, and wherein the first LED is configured to not extend in front of the first or second eye cup.

6. The electronic athletic pacing device of claim 3, further comprising:
eye-wear; and
a means for coupling the pacing device to the eye-wear.

7. The electronic athletic pacing device of claim 6, wherein the eye-wear is swim goggles having a first and second eye cup, wherein the means for coupling the pacing device to the eye-wear is configured to couple between the first eye cup and the second eye cup, wherein the pacing device is coupled between the first and second eye cup, and wherein the first LED is configured to not extend in front of the first or second eye cup.

8. The device of claim 7, wherein the means generating user inputs is one or more buttons, wherein the electronic module is configured enable the first timer, to set the first time period, start the first timer, and stop the first timer.

9. The electronic athletic pacing device of claim 2, further comprising;
a second LED, wherein the second LED is coupled to the electronic module;
a second timer, wherein the electronic module includes the second timer;
a means for controlling the second LED, wherein the second LED is configure to be visible by an athlete wearing the eye-wear when the pacing device is coupled to eye-wear, and wherein the electronics module is configured to generated a second indication with the second LED during each second time period, wherein the electronic module includes the means for controlling the second LED, and wherein the electronics module is configured to control the second timer.

10. The electronic athletic pacing device of claim 9, further comprising;
eye-wear; and
a means for coupling the pacing device to the eye-wear.

11. The electronic pacing device of claim 10, wherein the second indication is one or more blinks of the second LED at the end of the second interval time.

12. The electronic athletic pacing device of claim 10, wherein the eye-wear is swim goggles having a first and second eye cup, wherein the pacing device is coupled between the first and second eye cup, wherein the means to couple the pacing device to the eye-wear is configured to couple the pacing device between the first and second eye cup, and wherein the first LED and second LED are configured to not extend in front of the first or second eye cup.

13. The electronic athletic pacing device of claim 11, wherein the first LED produces light of one color and the second LED produces light of a second color.

14. The electronic athletic pacing device of claim 12, wherein the electronics module is configurable to an interval training mode, wherein when the second timer is reaches the end of each second time period, the first timer is restarted to time the first time period.

15. The electronic athletic pacing device of claim 13, wherein the second time period is greater than the first time period.

16. An electronic athletic pacing device comprising;
a first LED;
one or more buttons configured to generate user inputs;
a display;
an electronics module comprising a first timer and a second timer, a means for controlling the first LED, a means for controlling the second LED, a means to control the display, and a means to receive the user inputs,
swim goggles having a first cup and a second cup; and
a means for coupling the pacing device to the eye-wear;
a second LED, wherein the second LED is coupled to the electronic module; and
an enclosure encapsulating the electronics module and the display,
wherein the electronics module is coupled to the first LED, the second LED, the one or more buttons, and the display, wherein the electronics module is configured to control the first timer to repetitively time a first time period and control a second timer to repetitively time a second time period, wherein the first and second LEDs are configure to be respectively in the peripheral vision of an athlete's first eye and second eye when wearing the swim goggles and the pacing device is coupled to eye-wear, wherein the electronics module is configured to generated flash one or more times from the first LED at the end of each first time period, wherein the electronics module is configured to generate one or more flashes wherein the electronic module is configured to enable the first timer and second timer, to set the first time period and second time period, start the first timer and the second timer, and stop the first timer and second timer, wherein the electronics module is configured to blink the second LED one or more times at the end of the second interval time, wherein the first LED is configured to be seen by an athlete's first eye and the second LED is configured to be seen by the athlete's second eye when the eye-wear is worn by the athlete, wherein the first LED produces light of one color and the second LED produces light of a second color.

17. An electronic pacing device comprising;
an electronic module that includes GPS electronics, a means for controlling a first LED, a means to control a display, and a means to receive user input;
a first LED coupled to the electronics module;
a means for setting a first average rate coupled to the electronics module;
a means for coupling the pacing device to a pair of swim goggles;
a display coupled to the electronics module; and
a case encapsulating the electronics module, first LED, and display, wherein the pacing device is water resistant and configured to be powered by a battery, wherein the electronics module is configured to read an average, wherein the first LED and the means for coupling the device to the pair of swim goggles is configured so that the LED is viewable by a person wearing the swim goggles.

18. An athletic interval training device comprising:
a means for generating a first visual indication;
a means for generating a second visual indication;
a means for configuring a first time period and a second time period;
a means for displaying the first time period and the second time period;
a means for repetitively timing the first time period; and
a means for repetitively timing the second time period,
wherein at the end of each first time period the means for generating a first visual indication generates a first visual indication, wherein at the end of each second time period the means for generating a second visual indication generates a second visual indication.

19. The athletic interval training device of claim 18 further comprising a means for coupling the athletic interval training device to eye-wear.

20. The athletic interval training device of claim 19 wherein the means for repetitively timing the first time and the means to repetitively time a second time period is configured to restart the timing of the first time period each time the second timer reaches the end of the second time period.
